(19) United States
(12) Patent Application Publication
(10) Pub. No.: US 2006/0207841 A1
(43) Pub. Date: Sep. 21, 2006

(54) Centrifugal brakes for wheels

(75) Inventors: Michael T. Kidd, Delton, MI (US); Gerald L. Cline, Delton, MI (US)

Correspondence Address: SCOTT C HARRIS, P O BOX 927649, SAN DIEGO, CA, 92192, US

(73) Assignee: Jarvis/Pemco, Inc.

(21) Appl. No.: 11/080,290

(22) Filed: Mar. 15, 2005

(51) Int. Cl. F16D 59/00

(52) U.S. Cl. 188/184; 188/181 A

(57) ABSTRACT

A wheel assembly having a braking mechanism that is actuated by centrifugal force. The braking mechanism includes a rotating hub insert having a first pocket, a thread guard having a second pocket fixed relative to the frame of the wheel assembly, and an internal ball between the rotating hub insert and the thread guard. The internal ball can be flung by centrifugal force from the first rotating pocket to the second fixed pocket to cause a braking force from contact of the ball in the second pocket with the rotating hub insert. The amount of centrifugal force required to fling the ball into the second pocket can be calculated for rotation of the wheel greater than a certain predetermined speed.

### BACKGROUND

The present disclosure relates to a braking mechanism in a wheel assembly that is actuated by centrifugal force. More particularly, the disclosure relates to a braking mechanism having an internal ball that is flung by centrifugal force from one rotating pocket to another pocket in association with the braking force.

Casters are small wheels that are attached to objects to make them easier to move. Often, controlling the speed of the object using the casters is desirable. For example, shopping carts, furniture moving carts, trolleys, baby walkers, or wheelchairs may have braking mechanisms to slow the object or avoid runaway carts. Damage or injury may occur if carts move too quickly or out of control. For example, an unattended shopping cart can roll due to wind or an incline into objects or people.

Certain brake mechanisms require the user to manually operate a brake. However, such manual brakes are often inconvenient, and the user cannot always be relied upon to set the brake when use of the cart is finished. Other mechanical brakes can operate automatically without user intervention. A braking mechanism that is actuated by centrifugal force created when the wheel is rolling faster than a certain predetermined speed is particularly advantageous to stop runaway carts or to help maintain carts below a predetermined speed. The automatic operation avoids the necessity to be engaged or activated by the user of the cart.

The terms “brake” and “braking” as used in this disclosure include both slowing and stopping. It includes reducing the speed of a cart as well as a stopping action. Certain other prior art brakes are meant to completely stop the rotation of a wheel, but in the present disclosure, “braking” is specifically intended to include slowing the rotation of the wheel.

Braking mechanisms that automatically operate are known in the art. Friction brakes, such as U.S. Pat. No. 5,002,163, are used for self-decelerating wheels. Additional types of devices including hooks, springs, brake shoes, brake pawls, ratchets, etc. have not always held up well in the field. Other patents disclose activation by centrifugal force or using an internal ball to assist with braking.

U.S. Pat. No. 3,623,575 discloses a wheel with a locking device including two movable locking members. A series of notches (8) are formed in the inner circular edge of a ring 9 of a wheel rim. Two balls (12) are each in opposing inclined tubular guideways. Each locking member engages when the floor is inclined so gravity causes the ball to roll into a notch. This stops and holds a cart from rolling downhill.

U.S. Pat. No. 5,607,030 discloses a centrifugal shopping cart brake that engages when a predetermined speed is reached. The braking mechanism is enclosed within the wheel and operates with rotating weights and ratchet assemblies. Sliding weights 4 are moved by centrifugal force against an object having spring resistance. In another example, at a predetermined speed, a tang 55 on an arm 54 engages ratchet teeth that transfers energy to a ring and friction band to slow the wheel. Alternately, in FIG. 15, a weight 61 on a lever arm rotates due to centrifugal force and pushes on an object having spring resistance.

U.S. Pat. No. 6,070,701 discloses a wheel having a roller 50 that operates in a semi-spherical half 30 of a wheel to act as a brake and reduce speed. The ball in between a stop piece 40 and the wall of the semi-spherical half of a wheel, and a slide way 42 has a variable width. When the wheel is rolled to a predetermined speed, the ball moves to the narrower width of the slide way, and the friction force of the ball on the stop piece/wall half acts as a braking force.

U.S. Pat. No. 6,076,839 discloses, as best seen in FIG. 3, a safety brake device using a ball. FIG. 3 with the ball is cited prior art to that patent, and FIG. 6 is the brake device of the '839 patent using a cylindrical pillar. FIG. 3 shows ball 18 inside an arched trough 17 of the ring groove 15. On each end of the trough are protruding arcs 23 of the fixed piece (block) 19 that form a tapered cavity narrower than the ball. When moving slowly, the ball remains in the lower wider portion of the arched trench. When the ball moves with centrifugal force, the friction of the ball against an arch 23 causes some braking action. FIG. 6 shows a cylindrical pillar 43 in a space with an obliquely arched edge 47, wherein friction of the pillar against walls of the internal space having a narrowing arch.

U.S. Pat. No. 6,332,513 discloses a safety wheel having a ball 4 in an elongated trench 34 inside half of a wheel. The ball rolls to the lower end of the trench due to gravity when the wheel moves at slower speeds. The trench changes position when the wheel rolls. A side cover 5 has a stopping part 53 that does not rotate. At higher speeds, the ball does not roll to the lower end and stays in one end of the trench due to centrifugal force, and when this happens, the ball will be stopped by the stopping part and the wheel stops rolling.

U.S. Pat. No. 6,374,954 discloses a speed control caster. A ball is in a chamber between the inner walls of two wheels on each side of an axle. The inner walls 22 are tapered forming a narrowing chamber for the ball as seen in FIG. 5B. A braking effect occurs due to friction between the axle piece and the walls due the rubbing of the ball when the ball is swept upward by the curves 23.

One aspect of many of these wheels is that the brakes completely stop rotation, rather than a slowing braking action. Also, others do not automatically disengage in one rotation of the wheel after decelerating below a predetermined speed or the device must be stopped or reversed to disengage the brake.

These do not include a rotating insert with a pocket that flings a ball into a fixed pocket located in the wheel's thread guard that accepts the ball due to centrifugal force at a predetermined speed of the wheel, wherein the ball in the fixed pocket acts as a brake due to friction with an outer ring of the insert.

### SUMMARY

The present invention is for centrifugal brakes for wheels using an internal ball that may be forced from a pocket by centrifugal force. A preferred wheel assembly has a centrifugal brake including a ball, a rotating hub insert and a thread guard. A rotating hub insert has a pocket for a ball used in conjunction with a fixed pocket in the thread guard that accepts the ball due to centrifugal force at a predetermined speed. The term “pocket” in this disclosure is meant to broadly cover any receptacle, cavity or opening.

Instead of hooks, springs, brake shoes, brake pawls, or ratchets, the present disclosure includes a brake with only one new moving part, a ball (i.e. ⅜ inch steel), to the wheel for the intended braking use. The simplicity of the design allows for increased durability and performance, while being less costly to make and quieter to operate than other designs.

The centrifugal brake in this disclosure automatically slows the wheel at a predetermined speed to avoid runaway carts and associated damages or injury. Also, the centrifugal brake automatically disengages in one rotation of the wheel after decelerating below a predetermined speed. The braking mechanism is internal so environmental conditions or debris cannot easily spoil, ruin, hamper, encumber or obstruct the wheel.

A pocket for the ball on the circumference of the rotating insert is used in conjunction with a fixed pocket located in the thread guard.

As an example only, an intended use for the centrifugal brake for a wheel is for a shopping cart, but this is not meant to limit the invention because it is apparent that the centrifugal brake could be used for a baby walker, wheelchair or other objects. The centrifugal brake for a wheel can be designed to be used on a shopping cart to control the speed of a runaway cart. The wheel assembly has a braking mechanism activated by centrifugal force created when the wheel is rolling faster than a certain predetermined speed, such as 3.5 miles per hour. The brake engages at the predetermined speed and creates a braking motion to slow the wheel. The predetermined speed can be regulated for each use based on components used in making the wheel assembly. The brake is intended to automatically disengage when the speed of the cart is slowed below the predetermined speed and the cart has rolled for at least a full revolution of the wheel.

The braking force applied is weak enough to not impede the shopper or user who insists on walking faster than the predetermined speed, but it is strong enough to slow down an unattended shopping cart that is coasting in a parking lot to avoid or minimize damage of the cart hitting parked cars or other objects. Similarly, the centrifugal brake for a wheel can control the speed of furniture moving carts on a ramp or baby walkers and wheelchairs on an incline.

As shown in the storyboard of FIGS. 13-20, the brake works when the speed of the wheel exceeds a predetermined speed, creating enough centrifugal force to fling the ball out of a pocket of the rotating insert into a fixed pocket located in the thread guard. One or both thread guards may have two anti-rotational ribs or stops on either side of the caster fork legs to keep the thread guard fixed relative to the legs. The ball is then trapped and pinched between the thread guard and the insert's outer ring of preferably soft polyurethane. The wheel will continue to roll, but the drag, friction or resistance of the trapped ball will slow the wheel as it is pushed over the soft polyurethane ring until the ball reaches the pocket of the rotating hub insert. If the wheel is still rolling too quickly, the ball will not drop back into the insert pocket, thereby starting another rotation of the braking action. When the wheel is traveling slower than the predetermined speed, the ball will drop back into the normal travel ball position in the insert pocket.

The soft polyurethane material is abrasion resistant and capable of deflecting with the ball, creating drag, and then springing back into its original shape. Polyurethane can be the same tough plastic material used for the tread of the shopping cart wheel.

This particular embodiment discloses use of a ball, such as the ⅜ inch steel ball as detailed, in conjunction with an insert ring adapted to work with the ball for braking action, but the ball could also include a variety of friction and anti-friction ball bearings, including different dimensions, sizes, materials, and weights. More or less friction, drag or resistance (braking force) can be generated by varying the interference fit of the ball with the polyurethane ring and the thread guard. Changing the diameter of the ring where the ball travels can change the speed required to centrifugally fling the ball, actuating the braking action. The weight and size of the ball can also affect the traveling speed when braking action occurs. The braking action slows motion by contact friction, but does not necessarily completely stop the rotation of the wheel.

An optional feature of adding serrations to the ring surface of the insert can produce a pulsing effect to help identify when the brake is engaged. The optional serrated insert could be made of compressible, abrasion resistant polyurethane.

### BRIEF DESCRIPTION OF THE DRAWING

The features of this disclosure and the manner of obtaining them will become more apparent, and the disclosure itself will be best understood by reference to the following description of embodiments of the brake for a wheel taken in conjunction with the accompanying drawing in which FIGS. 13-20 show a storyboard of the function and operation of the centrifugal brake, and others show particular embodiments of the centrifugal brake assemblies, wherein:

FIG. 1 shows a side view of an embodiment of a wheel assembly;

FIG. 2 shows a cross sectional view of a wheel assembly through a vertical center axis;

FIG. 3 shows a side view of a wheel, insert and dual sealed bearing;

FIG. 4 shows an inner side view of a thread guard;

FIG. 5 shows a cross sectional view of a thread guard through a vertical center axis;

FIG. 6 shows an outer side view of a thread guard;

FIG. 7 shows a side view of an insert;

FIG. 8 shows a cross sectional view of an insert through a vertical center axis;

FIG. 9 shows a side view of another embodiment of a wheel assembly having a damping material and serrations in the ring surface of the insert;

FIG. 10 shows a cross sectional view of a wheel assembly having a damping material and serrations in the ring surface of the insert through a vertical center axis;

FIG. 11 shows a side view of a wheel with an insert having serrations in the ring surface;

FIG. 12 shows a thread guard having a dampening material;

FIG. 13 shows a wheel at rest or at travel slower than the predetermined speed with the ball resting in the pocket of the insert;

FIG. 14 shows the ball remaining in the pocket at rest or at travel slower than the predetermined speed;

FIG. 15 shows the ball approaching the fixed pocket;

FIG. 16 shows the ball being centrifugally flung out of the pocket of the insert into the fixed pocket of the thread guard;

FIG. 17 shows the ball being trapped and pinched between the thread guard and a ring surface of the insert;

FIG. 18 shows the ball being pushed over the ring surface of the insert;

FIG. 19 shows the ball reaching the pocket of the insert;

FIG. 20 shows the ball dropping back into the normal travel ball position in the pocket of the insert.

### DETAILED DESCRIPTION

While the present invention will be fully described hereinafter with reference to the accompanying drawings, in which particular embodiments are shown, it is to be understood at the outset that persons skilled in the art may modify the embodiments disclosed herein while still achieving the desired result. Accordingly, the description that follows is to be understood as a broad informative disclosure directed to persons skilled in the appropriate art and not as limitations of the present disclosure.

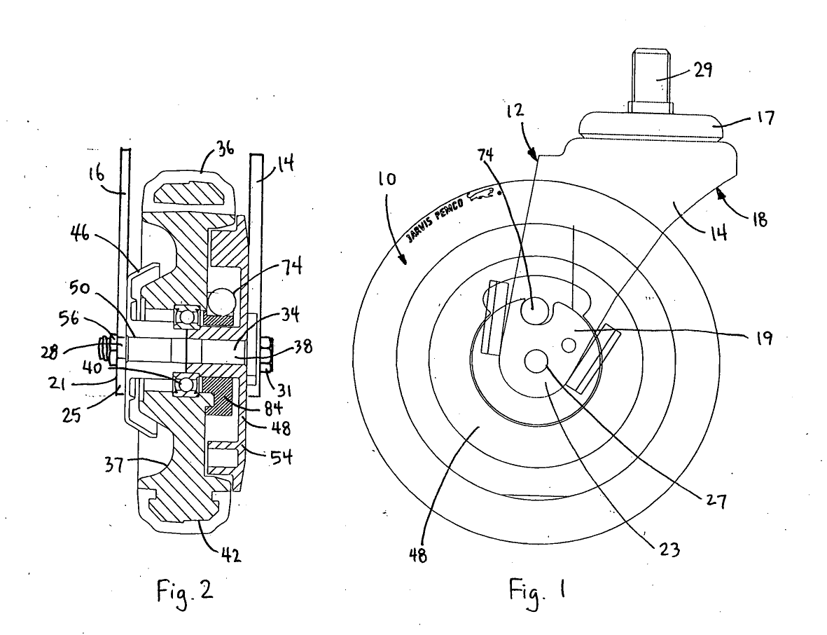

FIGS. 1 and 2 show a wheel assembly 10 as part of a caster 12 as often set between a pair of legs 14 and 16 connected by a base 17 of an inverted U-shaped frame 18 of which legs 14 and 16 are a part thereof. Preferably, the legs 14 and 16 extend away from the base 17 parallel to each other. The legs 14 and 16 preferably taper in width as they extend away from the base 17. The ends 19 and 21 of legs 14 and 16 may be semi-circular, forming substantially U-shaped end portions 23 and 25. Each end portion 23 and 25 has a hole 27 and 28 respectively concentric with the semi-circular ends 19 and 21. The base 17 of the frame 18 can be attached by a stem 29 extending therefrom to a shopping cart, furniture moving cart, trolley, baby walker, wheelchair or other objects with a potential for wheels. The stem 29 can also be threaded. The base 17 may be a plate for various types of attachment to objects.

The legs 14 and 16 straddle the wheel assembly 10 and a bolt 31 may extend through a pair of axially aligned holes 27 and 28 in the legs 14 and 16 and a hollow interior 33 of an axle 34 to render the wheel assembly 10 relatively rotatably supported on the frame 18. Preferably, the base 17 includes a swivel to permit free turning of the caster 12 relative to the cart or similar other objects. As such, the wheel 36 may rotate in one direction. The particular preferred frame is not meant to limit the invention, and “frame” may include a structure designed to hold the wheel 36.

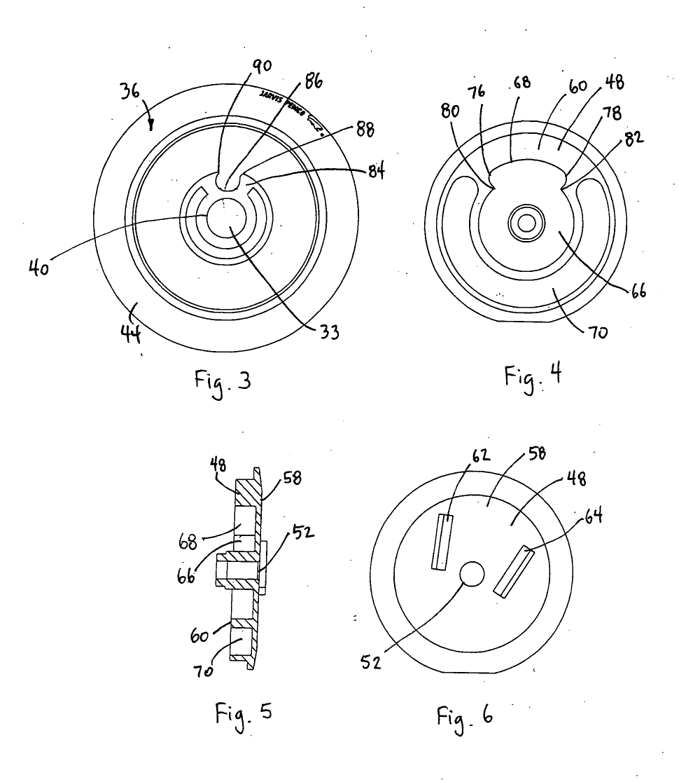

Wheel 36 may have a hub 37 with a central opening 38. A bearing assembly 40 is preferably mounted in the opening 38, and the bearing assembly 40 is preferably dual sealed, as shown in FIG. 3. FIG. 10 shows a common 6002ZZ precision ball bearing. Regarding bearing assemblies, roller bearings carry heavier loads while ball bearings roll more easily but carry lesser loads. The wheel 36 can be rotatably supported on a cylindrical axle 34 by means of the bearing assembly 40. As such, the axle 34 can be part of the bearing assembly 40. The radial periphery 42 of the hub 37 preferably defines a tread mounting surface. The outer periphery 42 of the hub 37 may have synthetic resin material tread 44 secured thereto. A moldable synthetic resin tread material, particularly polyurethane, may be used as the tread 44.

The thread guards 46 and 48 each have a circular hole 50 and 52 respectively. Thread guards 46 and 48 are on opposite side of the wheel 36. As shown, the small thread guard 46 may be made from a compressible or flexible nylon or similar wear-resistant material. The thread guard 48 forming a housing 54 is preferably made from a rigid nylon or similar wear-resistant material. Holes 27 and 28 of the legs 14 and 16 are coaxially aligned with the holes 50 and 52 of the thread guards 46 and 48. The thread guards 46 and 48 are fixed against rotation relative to the frame 18. A bolt 31 may be inserted through a hollow interior 33 of the axle 34 and the sets of coaxially aligned holes 27 and 28 of the legs 14 and 16 are coaxially aligned with the holes 50 and 52 of the thread guards 46 and 48, respectively, so that the axle 34 is mounted upon the legs 14 and 16 of the frame 18. A nut 56 can be screwed on the threaded end of the bolt 31 in order to prevent removal of the bolt 31 from the frame 18.

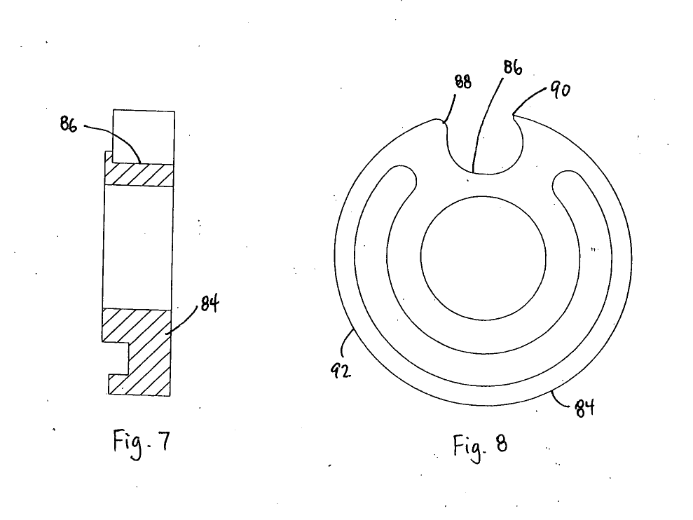

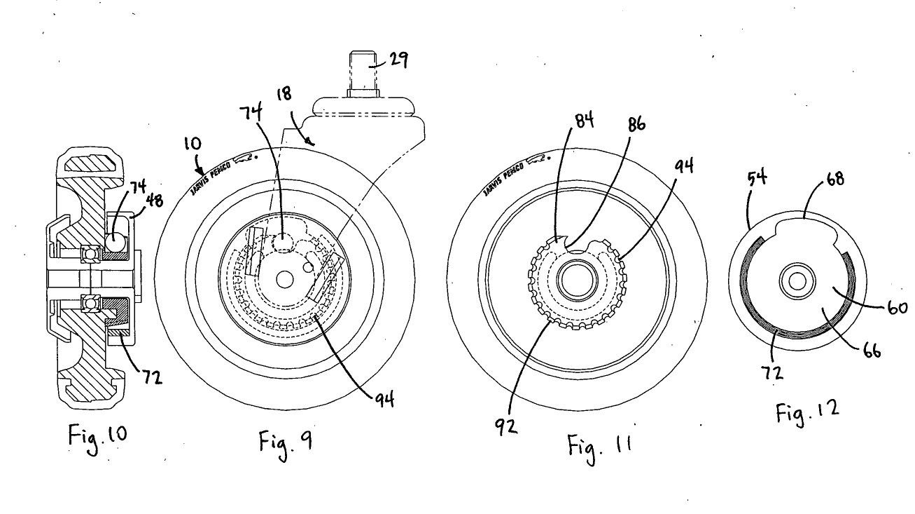

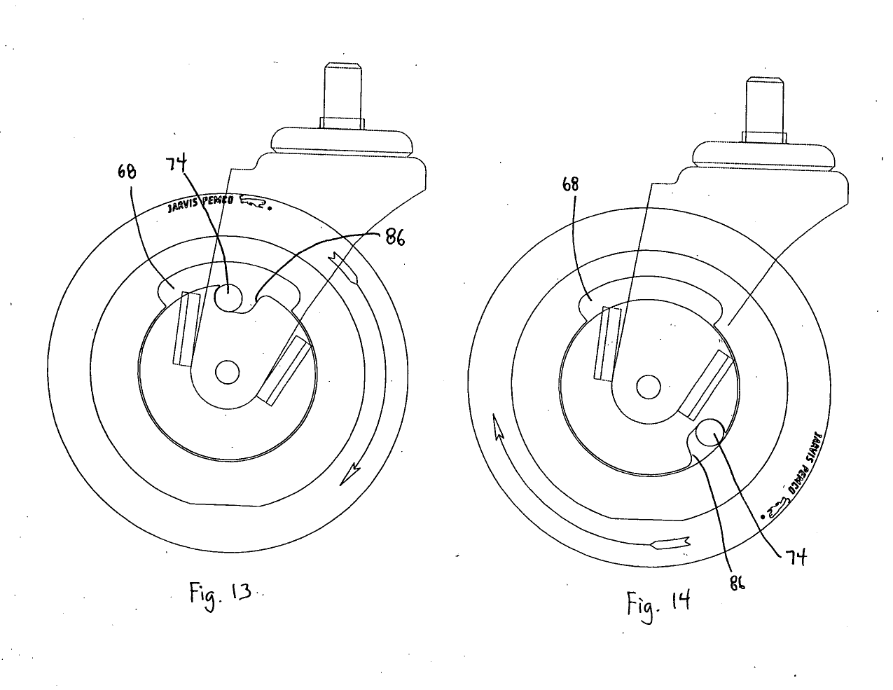

The thread guard 48 forming the housing 54 has an outer side 58 as shown in FIG. 6 and an inner side 60 as shown in FIG. 4. The outer side 58 preferably forms a circle extending to the outer periphery 42 of the hub 37 to minimize contamination of the wheel 36. The outer side 58 may have stops 62 and 64 on each side of end 19 of leg 14. The inner side 60 may have a recessed area 66 with a fixed pocket 68, which preferably remains at the top of thread guard 48. Other features of the thread guard 48 could be a semi-circular groove 70 on the inner side 60 as shown in FIG. 4 and a dampening material 72 as shown in FIGS. 10 and 12. As an option, a soft material can be adhered or molded to the inside of the thread guard 48 to absorb the clack of the ball 74 as the wheel 36 rotates. Preferably, this soft material is an elastomer that dampens sound and eliminates the clack and rattle of the moving ball 74. The groove 70 may extend around a portion of the thread guard 48 to form a wall as the portion of the perimeter of the recessed area 66 that does not include the fixed pocket 68. As shown in FIG. 12, the thread guard 48 can form a housing 54 without a groove and smaller than outer periphery 42 of the hub 37.

The fixed pocket 68 has rounded ends 76 and 78 forming corners 80 and 82 respectively. The area of the fixed pocket 68 between rounded ends 76 and 78 is sufficient to hold ball 74, but the pocket 68 is preferably shallower in the radial depth from hole 52 than the diameter of the ball 74. Thus, the ball 74 extends slightly from the pocket 68 when the ball 74 is in the pocket 68. The fixed pocket 68 is preferably about 80-90 degrees (shown at 87 degrees in the drawings) of the perimeter of the recessed area 66. The fixed pocket 68 is preferably at the top of the recessed area 66 so gravity will allow the ball 74 to drop from the fixed pocket 68 under the appropriate circumstances. Also, in operation, the ball 74 can be forced up against gravity (flung) by centrifugal force into the fixed pocket 68.

In the wheel assembly 10, a rotating insert 84 can be attached to the hub 37 or can be part of the hub 37. The rotating insert 84 is preferably located inside the recessed area 66 of the thread guard 48. The rotating insert 84 has a pocket 86. The insert pocket 86 is of sufficient size to hold the ball 74, and the insert pocket 86 may be the same depth as the diameter of the ball 74 or preferably slightly deeper. The insert pocket 86 has two edges 88 and 90. Leading edge 88 is preferably somewhat rounded with a slope into the pocket 86. The trailing edge 90 may form a lip so the pocket 86 forms a cup with a partial circumference similar to the ball 74. The trailing edge 90 forming a lip is preferred for a wheel 36 designed to rotate in one direction, such as for swivel casters. Edges 88 and 90 can both be rounded with a slope into the pocket 86 for wheel designed to rotate in both directions.

The outer radial surface of the insert 84 can be called the brake ring surface 92, which is adapted to work with the ball 74 for braking action. The brake ring surface 92 extends from edge 88 to edge 90 around the portion of the insert 84 not including the pocket 86. The ball 74 can be trapped and pinched between the thread guard 48 and a brake ring surface 92 of preferably soft polyurethane, which is capable of deflecting with the ball 74, creating drag, friction, or resistance, and then springing back into its original shape. More or less drag, friction, or resistance (braking force) can be generated by varying the interference fit of the ball 74 with the brake ring surface 92 and the thread guard 48. The brake ring surface 92 can include constant surface of the insert 84, an inserted semi-circular band, or similar circular objects with an aperture in the center. An optional feature of adding serrations 94 to the brake ring surface 92 can produce a pulsing effect to help identify when the brake is engaged. The brake ring surface 92 with optional serrations 94 could also be made of compressible, abrasion resistant polyurethane.

Ball 74 can be flung by centrifugal force from insert pocket 86 to fixed pocket 68 in association with the braking force. The ball 74 remains internal to the wheel assembly 10 between thread guard 48 and insert 84. For the shopping cart embodiment, a ⅜ inch steel ball is disclosed, but the ball 74 could also include a variety of friction and anti-friction balls, including different dimensions, sizes, materials, and weights. The ball 74 optionally may be lightly lubricated with grease or silicone to diminish built up frictional heat.

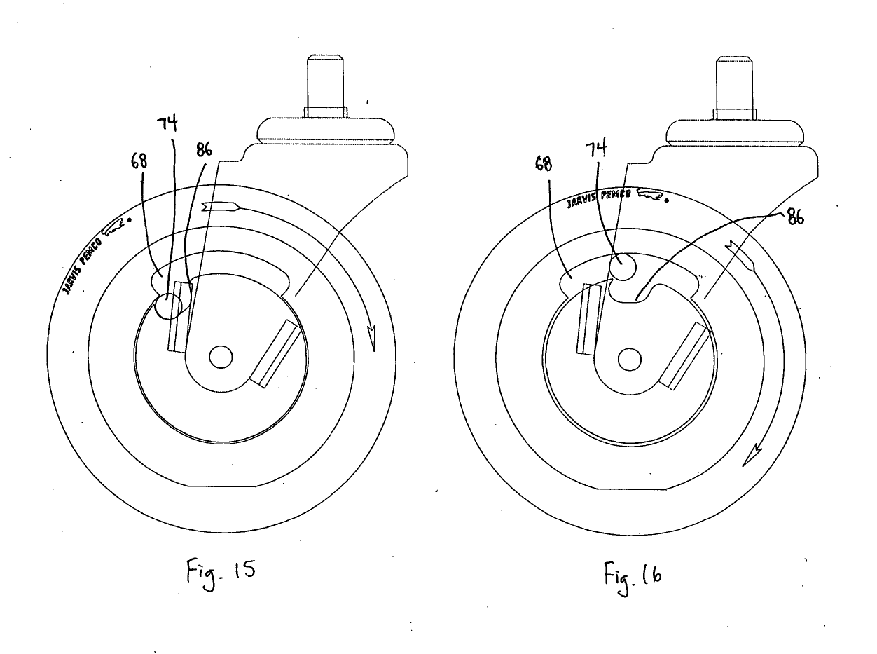

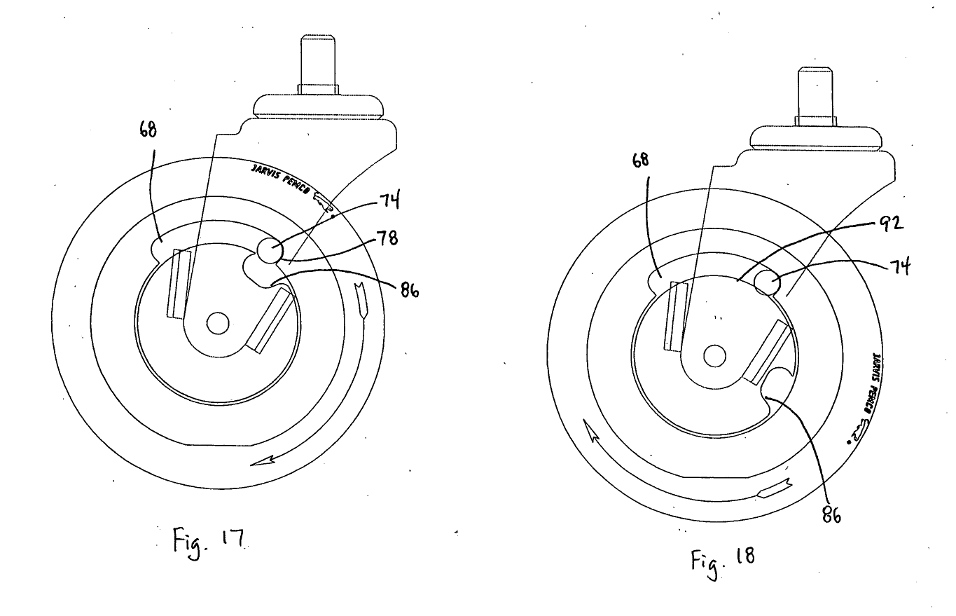

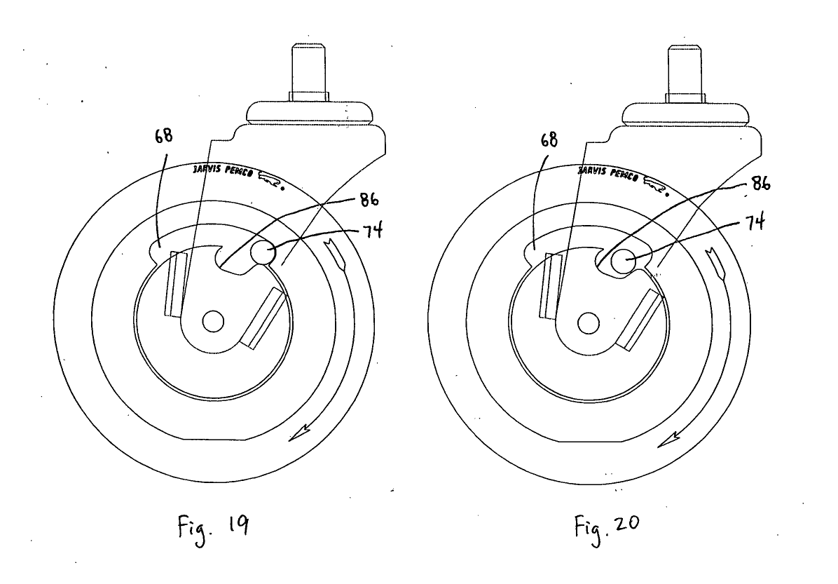

FIGS. 13-20 shows how the braking action works when the speed of the wheel 36 exceeds a predetermined speed, creating enough centrifugal force to fling the ball 74 out of a pocket 86 of the rotating insert 84 into a fixed pocket 68 located in the thread guard 48. FIG. 13 shows the wheel 36 at rest or at travel slower than the predetermined speed. The ball 74 rests in the pocket 86 of the insert 84. FIG. 14 shows the ball 74 remaining in the pocket 86 at rest or at travel slower than the predetermined speed. In FIG. 15, the ball 74 approaches the fixed pocket 68. In FIG. 16, the ball 74 is centrifugally flung out of the pocket 86 of the insert 84 into the fixed pocket 68 of the thread guard 48, such as when the wheel 36 is moving faster than the predetermined speed. In FIG. 17, the ball 74 is then trapped and pinched between the thread guard 48 and a brake ring surface 92 of the insert 84. The ball 74 is shown in the rounded end 78. As shown in FIG. 18, the wheel 36 will continue to roll, but the drag, friction, or resistance of the trapped ball 74 will slow the wheel 36 as the ball 74 is pushed over the brake ring surface 92—at least until the ball 74 reaches the pocket 86 of the insert 84 as shown in FIG. 19. If the wheel 36 is still rolling faster than the predetermined speed, the ball 74 will not drop back into the pocket 86 of the insert 84, thereby starting another rotation of the braking action. When the wheel 36 is traveling slower than the predetermined speed, the ball 74 will drop back into the normal travel ball position in the pocket 86 of the insert 84 as shown in FIG. 20.

Although preferred embodiments of the disclosure are illustrated and described in connection with particular features, it can be adapted for use with a wide variety of wheels. Other embodiments and equivalent assemblies, brakes, balls, and wheels are envisioned within the scope of the claims. Various features of the disclosure have been particularly shown and described in connection with illustrated embodiments. However, it must be understood that the particular embodiments merely illustrate and that the invention is to be given its fullest interpretation within the terms of the claims.

What is claimed is:

1. In a wheel assembly including a frame, the wheel assembly having a braking mechanism that is activated by centrifugal force, the braking mechanism comprising:
a rotating hub insert having a first pocket;
a thread guard having a second pocket fixed relative to the frame; and
an internal ball between the rotating hub insert and the thread guard;
wherein the internal ball can be flung from the first pocket to the second pocket by centrifugal force to cause a braking action from contact of the ball in the second pocket with the rotating hub insert.

2. The wheel assembly of claim 1 wherein an outer radial surface of the rotating hub insert is a brake ring surface that is capable of deflecting with the ball, creating drag, friction or resistance, and then springing back into its original shape.

3. The wheel assembly of claim 2 further comprising serrations on the brake ring surface of the rotating hub insert.

4. The wheel assembly of claim 1 wherein the rotating hub insert is soft polyurethane.

5. The wheel assembly of claim 1 wherein the second pocket of the thread guard is above the rotating hub insert.

6. The wheel assembly of claim 1 wherein the second pocket is shallower in a radial depth than a diameter of the ball.

7. The wheel assembly of claim 1 wherein the rotating hub insert is within a recessed area of the thread guard.

8. The wheel assembly of claim 7 wherein the second pocket is about 80-90 degrees of a perimeter of the recessed area.

9. The wheel assembly of claim 1 wherein the thread guard has a semi-circular groove on an inner side.

10. The wheel assembly of claim 1 wherein the thread guard has a dampening material on an inner side.

11. The wheel assembly of claim 1 wherein the first pocket has a leading edge that is somewhat rounded with a slope into the first pocket and a trailing edge forming a lip, wherein the first pocket forms a cup with a partial circumference similar to the ball.

12. A self-decelerating wheel assembly with a braking mechanism that is actuated by centrifugal force, the wheel assembly comprising:
a frame;
a wheel including a rotating hub;
an insert fixed with the rotating hub, the insert having a first pocket on a circumference of the insert;
a thread guard having a second pocket fixed relative to the frame; and
a single internal brake ball between the rotating hub and the thread guard;
wherein the braking mechanism is actuated by centrifugal force created when the wheel is rolling faster than a certain predetermined speed wherein the internal ball can be flung from the first pocket to the second pocket by centrifugal force in association with a braking action on the hub when the internal brake ball in the second pocket acts as a brake due to contact with the insert.

13. The wheel assembly of claim 12 further comprising a bearing assembly mounted in a central opening of the hub.

14. The wheel assembly of claim 12 wherein the braking action applied is weak enough to not completely stop rotation of the wheel at a speed faster than the predetermined speed.

15. The wheel assembly of claim 12 wherein the frame is pair of legs connected by a base of an inverted U-shaped frame, one of said legs attaching to a center portion of the thread guard fixed relative to the frame, the thread guard further comprising a stop on each side of one of said legs to fix the thread guard relative to the frame.

16. The wheel assembly of claim 12 further comprising a tread attached on an outer periphery of the hub.

17. The wheel assembly of claim 16 wherein the thread guard forms a housing extending to the outer periphery of the hub.

18. The wheel assembly of claim 12 wherein an outer radial surface of the insert is a brake ring surface that is capable of deflecting with the internal brake ball, creating drag, friction or resistance, and then springing back into its original shape.

19. The wheel assembly of claim 18 further comprising serrations on the brake ring surface of the insert.

20. The wheel assembly of claim 12 wherein the insert is soft polyurethane.

21. The wheel assembly of claim 12 wherein the second pocket of the thread guard is above the insert.

22. The wheel assembly of claim 12 wherein the second pocket is shallower in a radial depth than a diameter of the internal brake ball so the internal brake ball extends slightly from the second pocket when the internal brake ball is in the second pocket.

23. The wheel assembly of claim 12 wherein the insert is within a recessed area of the thread guard.

24. The wheel assembly of claim 23 wherein the second pocket is about 80-90 degrees of a perimeter of the recessed area.

25. The wheel assembly of claim 12 wherein the thread guard has a semi-circular groove on an inner side.

26. The wheel assembly of claim 12 wherein the thread guard has a dampening material on an inner side.

27. The wheel assembly of claim 12 wherein the first pocket has a leading edge that is somewhat rounded with a slope into the first pocket and a trailing edge forming a lip, wherein the first pocket forms a cup with a partial circumference similar to the internal brake ball.

28. A self-decelerating wheel assembly with a braking mechanism that is actuated by centrifugal force, the wheel assembly comprising:
a frame;
a wheel including a rotating hub;
an insert fixed with the rotating hub, the insert having a first pocket on a circumference of the insert;
a thread guard having a second pocket fixed relative to the frame; wherein the second pocket of the thread guard is above the insert and wherein the insert is within a recessed area of the thread guard, and
a single internal brake ball between the rotating hub and the thread guard wherein a diameter of the internal brake ball is greater than a radial depth of the second pocket;
wherein the braking mechanism is actuated by centrifugal force created when the wheel is rolling faster than a certain predetermined speed wherein the internal ball can be flung from the first pocket to the second pocket by centrifugal force in association with a braking action on the hub when the internal brake ball in the second pocket acts as a brake due to contact with the insert.
